(19) United States
(12) Patent Application Publication
(10) Pub. No.: US 2015/0262262 A1
(43) Pub. Date: Sep. 17, 2015

(54) SYSTEM AND METHOD FOR RAISING FUNDS WHILE ENCOURAGING WELLBEING AND ENVIRONMENTAL SUSTAINABILITY

(71) Applicant: Daniel Carvajal, Louisville, KY (US)

(72) Inventor: Daniel Carvajal, Louisville, KY (US)

(73) Assignee: HUMANA INC., Louisville, KY (US)

(21) Appl. No.: 13/037,995

(22) Filed: Mar. 1, 2011

Related U.S. Application Data
(60) Provisional application No. 61/309,673, filed on Mar. 2, 2010.

(51) Int. Cl. G06Q 99/00; G06Q 30/00

(52) U.S. Cl. CPC G06Q 30/0279

(57) ABSTRACT

A computerized system and method for the creation and management of fundraising events. The system and method support creation of fundraising groups comprising team members that participate in physical activity to raise donations for a certain entity or organization. Individual team members utilize a device (e.g., pedometer) that measures activity during a specified time period. Pledges for donations are made by sponsors that log into a website and pledge to donate a certain amount of money based on the physical activity performed by a fundraising team member. Some fundraising groups may comprise multiple teams. Different teams of the same group may have different fundraising goals or objectives. The website of the system may link a fundraising group to its different fundraising teams. All teams of a fundraising group may raise money for a single entity or the teams of a fundraising group may raise funds for different entities.

### CROSS REFERENCES TO RELATED APPLICATIONS

This application claims priority to U.S. Provisional Patent Application Ser. No. 61/309,673, filed Mar. 2, 2010, titled SYSTEM AND METHOD FOR RAISING FUNDS WHILE ENCOURAGING WELLBEING AND ENVIRONMENTAL SUSTAINABILITY, the content of which is incorporated herein by reference.

### FIELD OF THE INVENTION

The present invention relates to systems and methods for fundraising. In particular, the invention relates to a computerized, physical activity-based fundraising and payment-tracking system that permits fundraising while promoting healthy and environmentally friendly behaviors.

### BACKGROUND AND SUMMARY OF THE INVENTION

Maintaining a healthy lifestyle is important for numerous reasons. First, it has a huge impact on the quality of a person's life. People who are healthy tend to be happier, and more successful in day to day endeavors. Furthermore, as the life span of individuals continues to grow, leading a healthy life increases the odds that the later years of life are enjoyable. Second, maintaining a healthy lifestyle can often times help improve the environment. The most common means of transportation such as cars, busses, trains, subways, etc. cause pollution. While science is helping to curb the amounts of pollution caused by these vehicles, the fact remains that walking is typically the most environmentally sound way of getting between two points. When people replace vehicle transport with walking or running as a means of bettering their health, the environment also benefits.

Unfortunately, there are many existing factors that encourage individuals to lead an unhealthy lifestyle. Today, people are busier than ever before. With most families having two working parents and children that are involved in numerous activities, it has become common place to rely completely on motorized vehicles for transportation. The fast-paced and overscheduled lifestyles of many—if not most—individuals has made squeezing in physical activity a luxury. This hectic pace has also made it difficult for individuals to participate in charitable activities. There is a need in the art for a system that combines physical activity with charitable giving in a manner easily accommodated by the busy lives of system users.

In a preferred exemplary embodiment, the present system and method comprises a website that provides for the creation and management of fundraising groups where the fundraising groups comprise team members that participate in physical activity to raise donations for a certain entity or organization. In a preferred exemplary embodiment, individual team members utilize a pedometer that measures the number of steps taken during a given time period. In some exemplary embodiments, pledges are made by sponsors that log into the website and pledge to donate a certain amount of money based on the physical activity performed by a fundraising team member.

Some fundraising groups may comprise multiple teams. Different teams of the same group may have different fundraising goals, fundraising objectives, etc. The website of the system may link a fundraising group to its different fundraising teams. In some exemplary embodiments, all of the teams of a fundraising group raise money for a single entity. In other exemplary embodiments, the teams of a fundraising group may be raising funds for different entities. An entity does not have to be a legal entity, but could be an organization, school, youth group, non-profit, etc.

In a preferred exemplary embodiment, each fundraising team member has a personal profile that may be accessed through the website. A personal profile page may permit an individual to enter physical activity, review physical activity, upload photos, post messages, send messages, etc. In some exemplary embodiments, a personal profile page displays fundraising goals and fundraising progress.

In some exemplary embodiments, the website of the present invention enables efficient fundraising by permitting pledge requests to be electronically sent to potential sponsors. In preferred exemplary embodiments, individuals may create sponsor accounts through the system's web page where the sponsor account enables the monitoring of pledge and donation activity. The sponsor account may also suggest fundraising groups to the sponsor based on the sponsor's pledge history.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 shows an exemplary embodiment of a web page that may be utilized to register a fundraising group.

FIG. 2 shows an exemplary embodiment of a group profile page.

FIG. 3 shows an exemplary embodiment of an individual fundraising team member's profile page where said profile comprises an avatar or other image.

FIG. 4 shows an exemplary embodiment of a member registration page.

FIG. 5 shows an exemplary embodiment of a pledge page.

FIG. 6 shows an exemplary embodiment of a sponsor sign in page that comprises a group and individual fundraising team member search function.

FIG. 7 shows an exemplary embodiment of a retail web page.

FIG. 8 shows a flow chart of an exemplary embodiment of the system and method of the present invention.

FIG. 9 shows a flow chart for providing startup kits for an exemplary embodiment of the system and method of the present invention.

### DETAILED DESCRIPTION

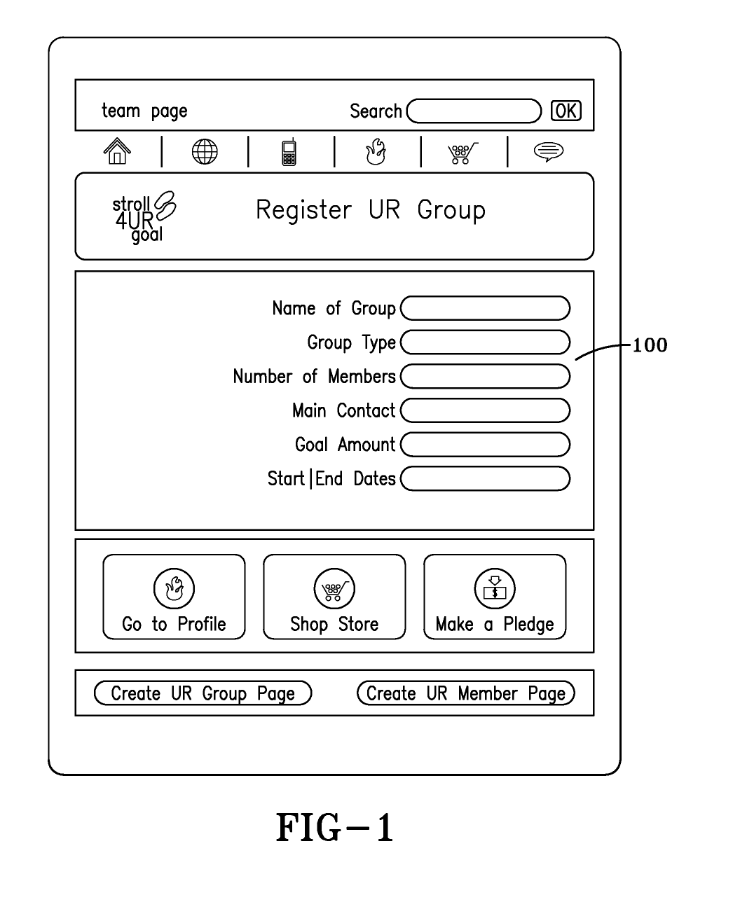

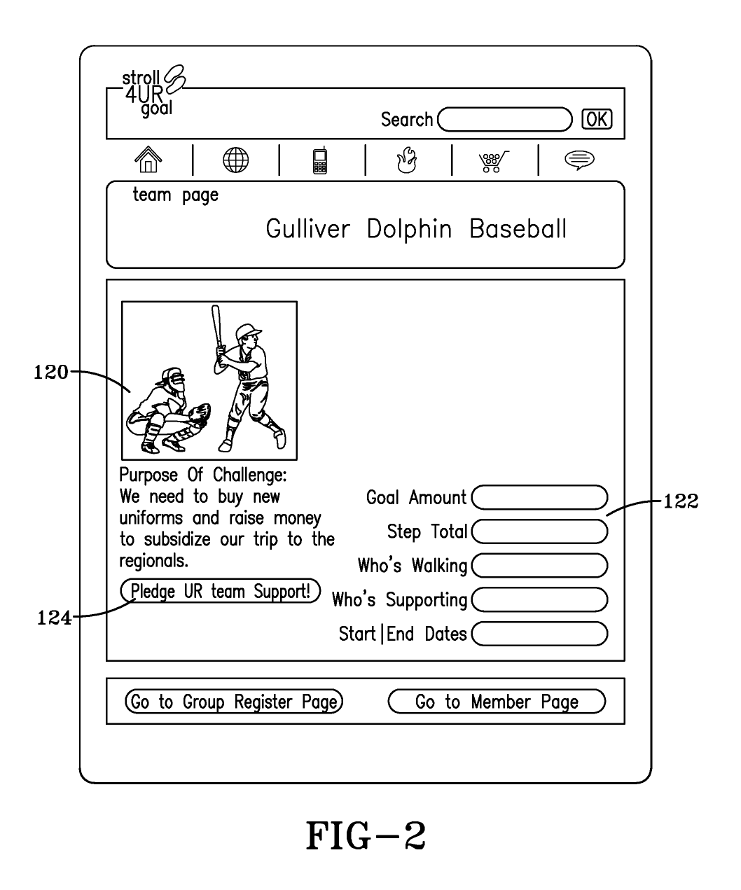

In one exemplary embodiment, the present invention comprises a website that permits an entity to log on and create a fundraising group. In a preferred exemplary embodiment, one website permits multiple fundraising groups to be created. A fundraising group may be created by accessing a page of the website and registering the group. FIG. 1 shows an exemplary embodiment of a web page that may be utilized to create a fundraising group of the present system and method. Some information that may be requested during registration 100 comprises the name of the group, the type of group, the number of members, the main contact, the fundraising goal amount, and the start and end dates of the fundraising period. In one exemplary embodiment, a system administrator creates a fundraising group while in other exemplary embodiments, any individual associated with an entity that needs to raise funds may access the website to create a fundraising group for the entity. In an exemplary embodiment, the individual that creates a fundraising group is designated to be the captain or team leader of the group. In some exemplary embodiments, a non-profit organization already in existence is registered through a website and thereby develops a fundraising group of the present invention.

In one exemplary embodiment, once a fundraising group has been created through the website, a group page for the fundraising group can be generated. In exemplary embodiments, the group page is automatically generated once the fundraising group has been created. In other exemplary embodiments, there is an option for creating a group page for the fundraising group after the fundraising group has been created. FIG. 2 shows an exemplary embodiment of a group page of the system of the present invention. In a preferred exemplary embodiment, a group page comprises information pertaining to the entity raising funds and why the funds are being raised 120. A group page may further comprise a fundraising goal and show the progress that has been made towards achieving the goal 122. A group page may comprise a link 124 to a page where donations may be made online to the fundraising group or the entity associated with the group.

In a preferred exemplary embodiment, a fundraising group comprises multiple team members. A fundraising group may be configured such that it comprises multiple teams where each team has multiple members. In another exemplary embodiment a team may have only a single member. Multiple teams of a fundraising group may raise funds for different purposes, have different fundraising goals, etc. For example, if a fundraising group is created for a given school, High School A, the fundraising group could be called High School A Fundraising. The High School A Fundraising group could comprise multiple fundraising teams. For example, there could be a separate fundraising team for each of the school's sports teams, musical groups, organizations, etc. When a fundraising group comprises multiple teams, a group page for the group may comprise a link for each of the teams where the link provides access to a team page. In some exemplary embodiments, a fundraising group with multiple teams has a group page where each of its teams is represented. When multiple teams are represented on a group page, information pertaining to each team may be provided on the page including the team's fundraising goal and progress made towards the goal.

In one exemplary embodiment, a fundraising group for an entity has been created and individuals are permitted to create teams to raise funds for the entity by accessing the entity's group page and requesting to create a fundraising team. In one exemplary embodiment, requesting to generate a fundraising team comprises registering the fundraising team online. For example, a cancer awareness group could create a fundraising group by accessing a website and could permit individuals across the country to create fundraising teams that would each raise funds for the awareness group. In some exemplary embodiments, a fundraising group associated with an entity may monitor and limit the teams that are created to raise funds for that entity.

In a preferred exemplary embodiment, once a fundraising team has been created, individuals sign up to become team members. In one exemplary embodiment, individuals sign up to become team members by accessing a website. FIG. 4 shows an exemplary embodiment of a member registration page of the system of the present invention. When an individual registers to become a fundraising team member, he or she may be asked for certain information 140 such as name, fundraising group name, user name, password, email, cell phone number, goal amount, birthday, etc. Identifying information may be required to sign up as a team member whereby only certain individuals are allowed to join a team. For example, a fundraising team for a school's football team may only permit the individuals that play football for the team to become fundraising team members and identifying information may be required prior to creating a team member profile. In some embodiments teams may permit open enrollment. In embodiments where a fundraising group does not comprise multiple teams, individuals may sign up as members of the group and all members are considered members of a single fundraising team.

In some exemplary embodiments, once an individual has enrolled in a fundraising team he or she is encouraged to purchase a fundraising kit. In a preferred exemplary embodiment, a fundraising kit comprises a pedometer, a promotional item, and informational flyers. In a preferred exemplary embodiment, a fundraising kit purchased by a fundraising team member comprises promotional materials where the promotional materials discuss the team member's fund raising goals and/or the group or team for which the individual is fundraising. In some exemplary embodiments, a fundraising kit is not purchased but fundraising team members must obtain a device for measuring physical activity which will require them to self-report activity data.

In some exemplary embodiments, an individual fundraising team member may be a member of more than one fundraising team. When an individual fundraising team member is a member of more than one fundraising team, he or she may have a member profile page for each fundraising team he or she is a member of. In other exemplary embodiments, a single member profile page is utilized despite membership in multiple fundraising teams.

In a preferred exemplary embodiment, fundraising team members raise funds for a team, group, or entity by participating in physical activity. In a preferred exemplary embodiment, the physical activity comprises walking that is measured by a pedometer. In another exemplary embodiment, the physical activity comprises running, swimming, bicycling, lifting weights, doing sit-ups, etc. In a preferred exemplary embodiment, performance of the physical activity is measured by an electronic device. In some exemplary embodiments, fundraising teams raise funds for their team, group, or entity by becoming healthier which may or may not require participation in a physical activity. For example, an individual may raise funds by losing weight. In some exemplary embodiments where individuals raise funds by participating in a physical activity or by becoming healthier, individuals log into a website to record their progress. For example, an individual fundraising team member that is raising money by swimming may access his or her team's page on a website of the present system and enter the number of laps he or she swam that day. In other exemplary embodiments, an electronic device that measures the physical activity of an individual raising funds may send a message to a computer where the message comprises physical activity data. In such an embodiment, the computer may be accessed by a website to update the team member's progress. In some exemplary embodiments, all members of a fundraising team partake in some specified form of physical activity in order to raise funds for their team. If an individual is a member of more than one fundraising group, the same physical activity may raise funds for both groups, but in some exemplary embodiments, separate physical activity may be required.

In some exemplary embodiments, a fundraising team member is a user of a portable electronic device that assists the user in maintaining a healthy lifestyle. The portable electronic device may comprise touch sensitivity to enable the taking of a biometric measurement of the user. In some exemplary embodiments the portable electronic device is preprogrammed for an individual user and notifies the individual user to perform physical activity. The portable electronic device may be able to detect when the physical activity has been performed, connect with a website of the present invention, and update the website with the individual user's physical activity. The portable electronic device may comprise an application for connecting with a website of the present invention.

In a preferred exemplary embodiment, a fundraising campaign is initiated for a fundraising team. A fundraising campaign may comprise a pledging period and a physical activity period. In an exemplary embodiment, the pledging period is a time during which fundraising team members may solicit donations for the entity, team, or group associated with their fundraising. In a preferred exemplary embodiment, pledges are made to an individual fundraising team member based on the individual's future performance of a physical activity during the physical activity period. For example, an individual may pledge one dollar for each 1,000 steps taken by a fundraising team member during the physical activity period. The physical activity period may be a set number of days during which a fundraising team must perform physical activity in order to raise funds for their team or group. In some exemplary embodiments, a pledge is made to an individual fundraising team member based on his or her completion of a certain number of steps. For example, an individual may pledge to donate $20 to an individual fundraising team member if he or she successfully takes 50,000 steps during the physical activity period. Pledges may also be made based on physical activity performed by a fundraising team or fundraising group.

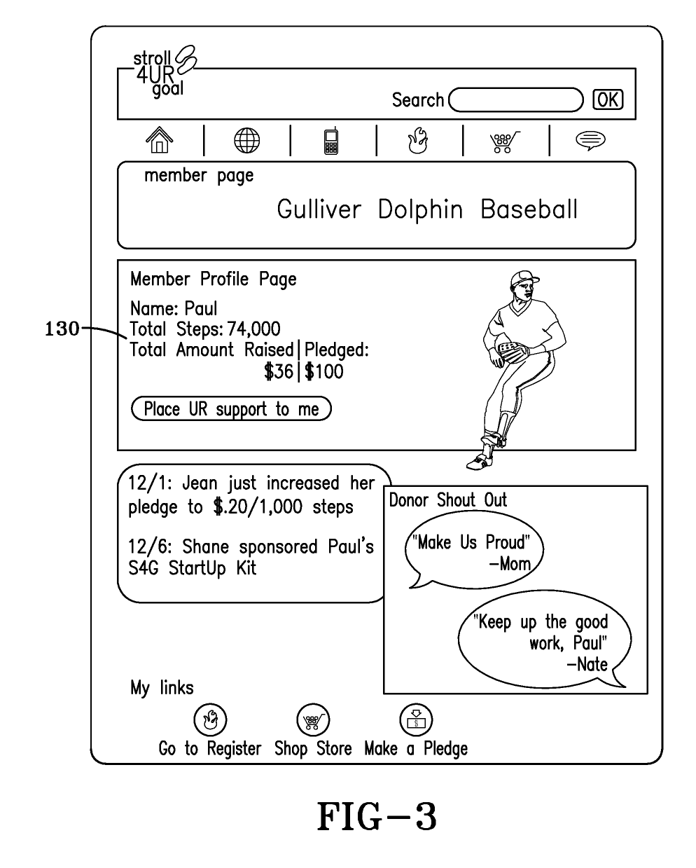

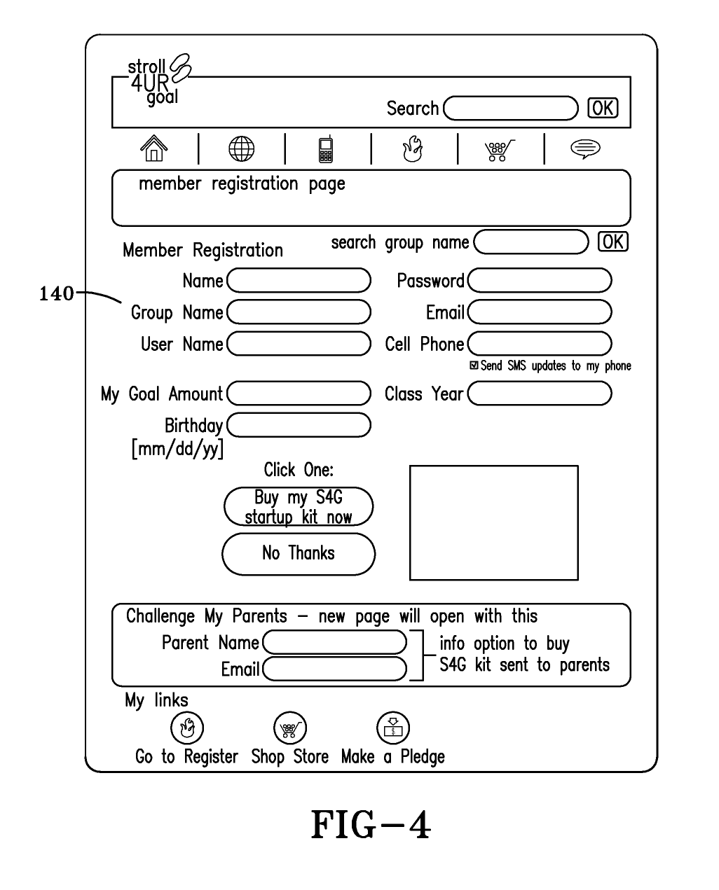

In preferred exemplary embodiments, each member of a fundraising team has a profile page on the website. In some exemplary embodiments, a fundraising team member may access his or her profile page in order to create and manage a personal fundraising account. In some exemplary embodiments, fundraising team members seek pledges from supporters by directing them to their profile on the website where they may pledge a donation amount. FIG. 3 shows an exemplary embodiment of a fundraising team member profile page of the present system where donation pledges can be made. In an exemplary embodiment where an individual fundraising team member is raising money by walking, the team member's profile page displays the total steps taken to date and the money earned to date by the team member 130. Fundraising team members may be able to upload photographs for display on their profile pages.

In a preferred exemplary embodiment, fundraising team members may utilize a website of the present invention to challenge others to raise funds for their team or group. A challenge may comprise an invitation to visit the website and make a donation, an invitation to become a fundraising team member, etc. In one example, an individual fundraising team member enters the email address of an individual he or she wishes to challenge into a field on a web page of the present invention and causes a challenge to be sent to the entered email address. In a preferred exemplary embodiment, a challenge comprises a link to a website of the present invention.

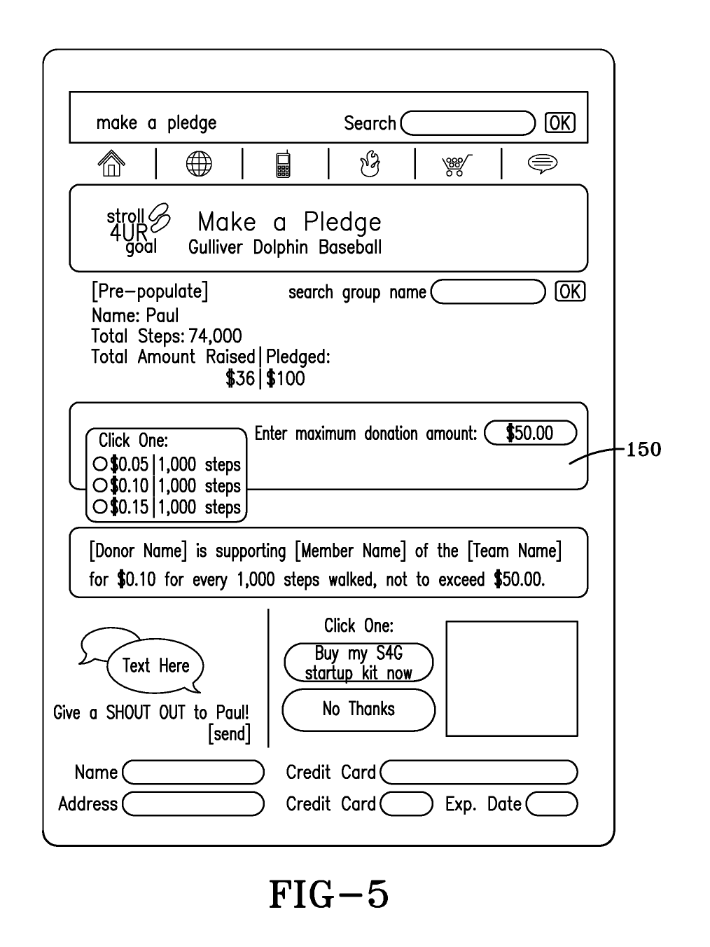

An exemplary embodiment of the present system comprises a payment tracking tool. The payment tracking tool may comprise a web page that permits individuals to make pledges to a fundraising group, fundraising team of a fundraising group, or to an individual fundraising team member. FIG. 5 shows an exemplary embodiment of a web page that permits individuals to make pledges. A web page that permits individuals to make payments may permit individuals to select from a variety of donation options 150. In a preferred exemplary embodiment, an individual may enter a donation pledge as well as his or her payment information (such as credit card account information) into the web page so that once the physical activity period has ended, the individual's donation is automatically collected. In some exemplary embodiments a web page comprises a messaging option so that once a donation has been pledged, the individual that has pledged the donation may electronically send a message notifying a fundraising team member, fundraising team, etc. of the pledge activity.

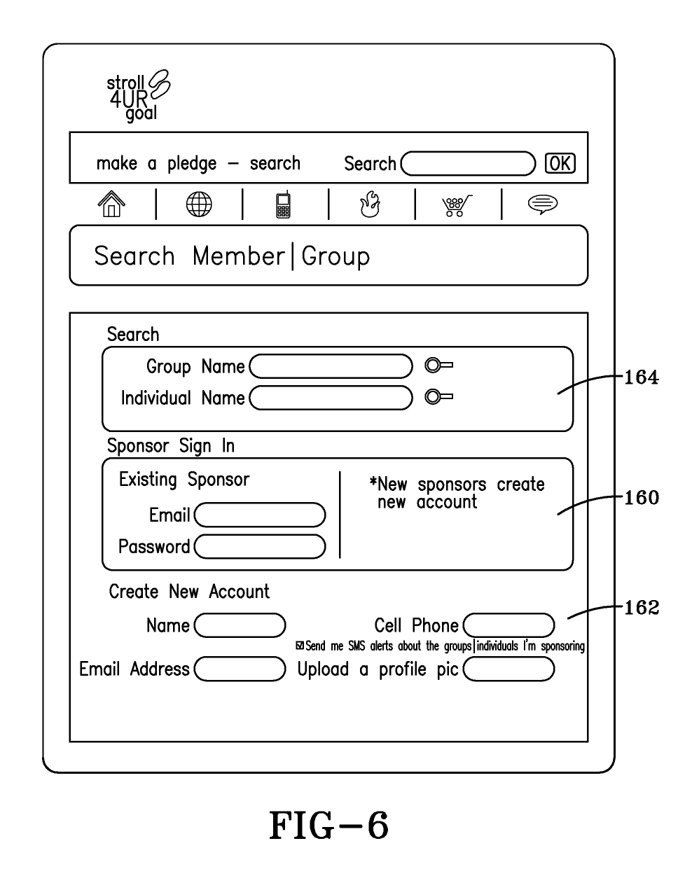

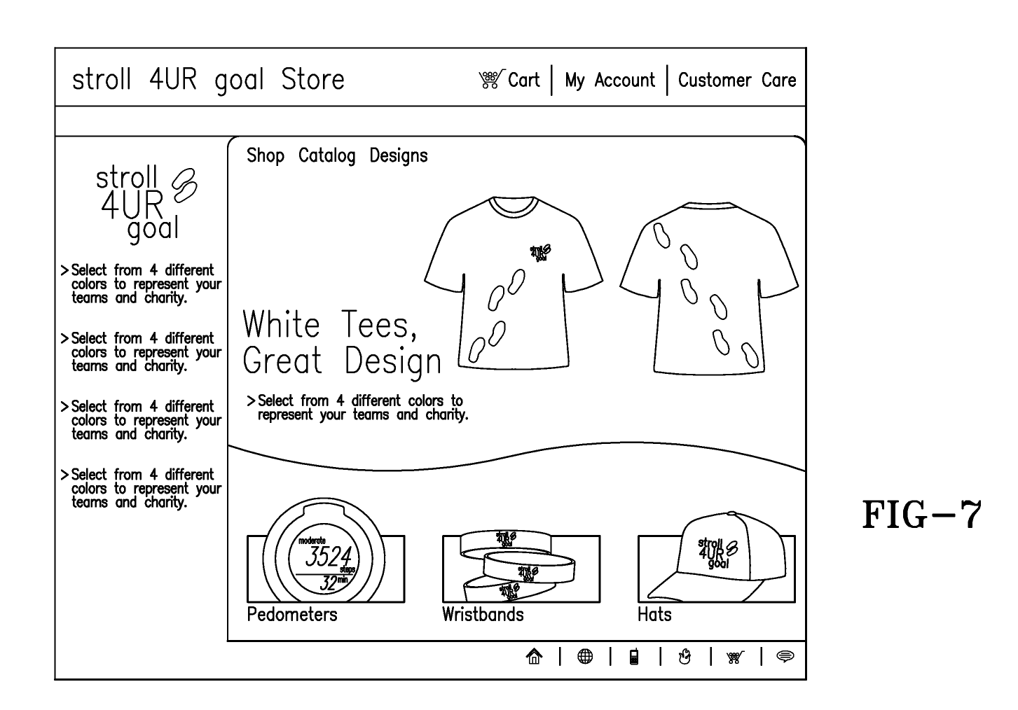

In a preferred exemplary embodiment, an individual creates a sponsor account prior to accessing a web page that permits the individual to make a pledge. A sponsor account may track all of the pledges the individual has made to fundraising groups, fundraising teams, individual fundraising team members, etc. In some exemplary embodiments, a sponsor account comprises a main web page that displays information relating to the sponsor's donation history. A web page of the sponsor account may contain a link to a fundraising group page, a fundraising team page, or an individual fundraising team member's profile page. In a preferred exemplary embodiment, a web page of a sponsor account contains a link for each donation that has been made by the sponsor. A sponsor account may contain links to fundraising groups to which the sponsor has not yet donated but may wish to donate to based on past donation history. For example, if a sponsor has made donations to certain children's wellness groups, additional fundraising groups that raise funds for children's wellness may be recommended to the sponsor. In some exemplary embodiments, recommendations to donate are made via email to a sponsor but are not necessarily contained in the sponsor's sponsor account. In other words, the sponsor may associate an external email account with his or her sponsor account and recommendations and other information may be sent to that account. In some exemplary embodiments, information emailed to a sponsor may also be displayed or otherwise made available in his or her sponsor account. FIG. 6 shows an exemplary embodiment of a web page that permits a sponsor to sign in to his or her account 160 and additionally permits an individual to create a sponsor account 162. A sponsor may be able to upload a photo or multiple photos into his or her sponsor account.

In some exemplary embodiments, a website of the system of the present invention comprises a page that permits individuals to search for fundraising groups, fundraising group teams, fundraising group team members, etc. FIG. 6 shows an exemplary embodiment of a web page that permits searching of fundraising groups and fundraising team members 164. A website of the present invention may also comprise a retail page where fundraising team members, fundraising sponsors, etc. may purchase products. Products that may be available for purchase include t-shirts, baseball caps, wristbands, pedometers, etc. In a preferred exemplary embodiment, a fundraising team member may access the retail page to purchase a product that displays the individual's fundraising accomplishments. FIG. 7 shows an exemplary embodiment of a retail page of the present system.

One exemplary embodiment comprises a system for raising funds through the performance of a physical activity where the system comprises a fundraising website. The fundraising website may be provided by a server in communication with a remote computer. Advertisements that discuss the fundraising website may be posted on a variety of websites such as social networking sites, shopping sites, etc. The ads may comprise a link to an informational video that may be viewed on a computer screen. In preferred embodiments, the informational video discusses the system of the present invention. An individual may see an ad for the fundraising website or view an informational video and decide to create a fundraising group through the fundraising website.

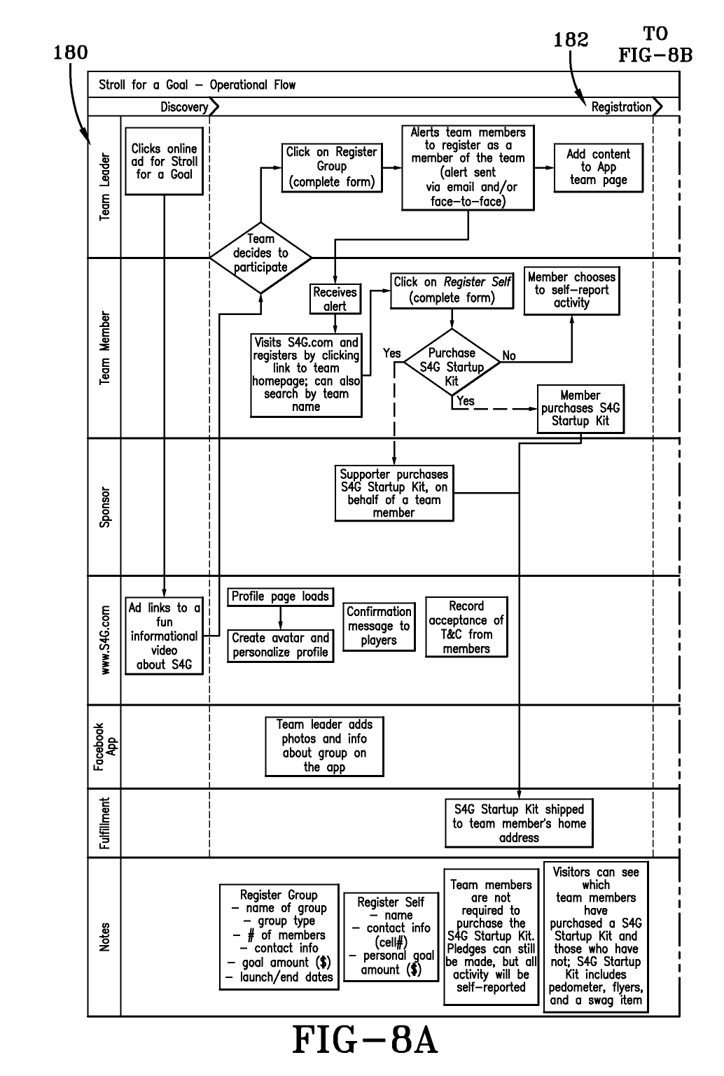

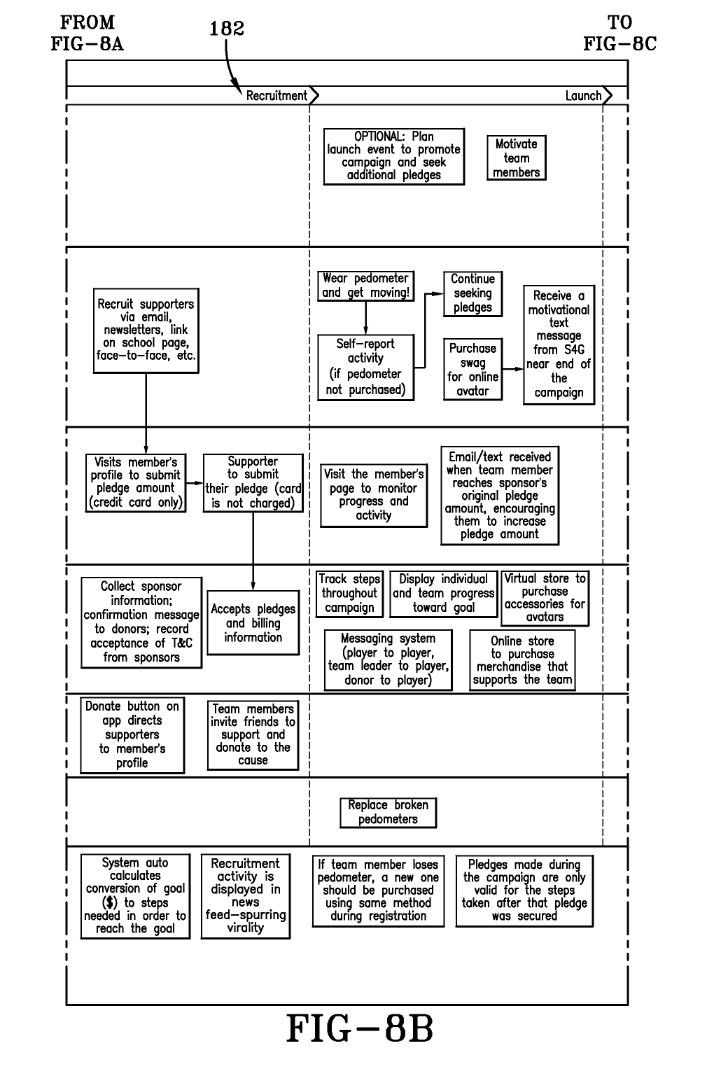

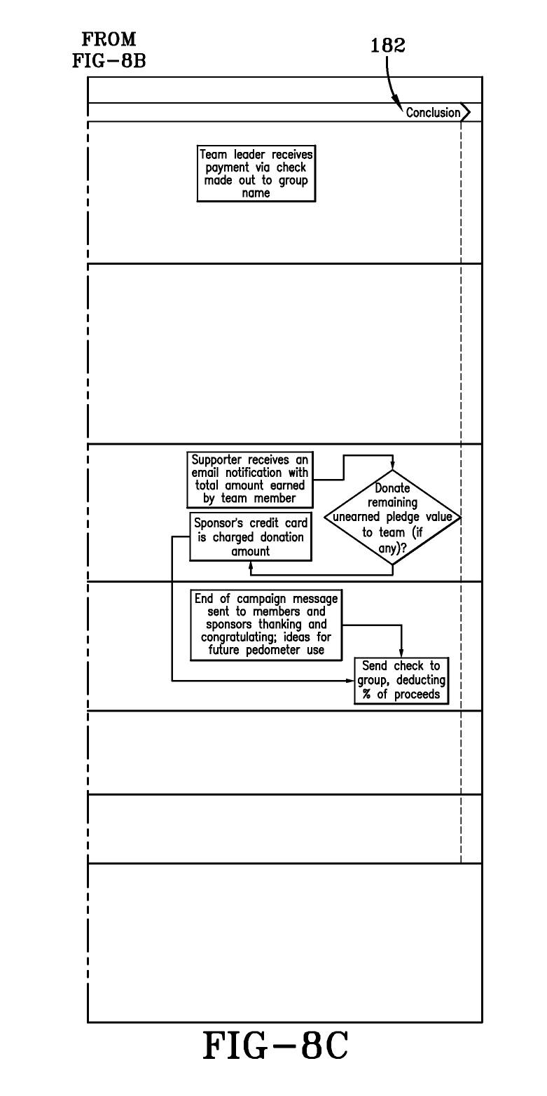

FIG. 8 provides a flow chart for how a fundraising group may be created through said website and how fundraising may proceed. The flow chart describes operations of the computerized system and method 182 (Discovery; Registration; Recruitment; Launch; Conclusion) performed for a plurality of entities 180 involved in a fund raising effort (Team Leader; Team Member; Sponsor; www.S4G.com; Social Networking Application; Kit Fulfillment).

In a preferred exemplary embodiment, a fundraising group is created by accessing a fundraising website and creating a fundraising group profile. The process of registering a fundraising group may comprise sending a request to a server that is in communication with a database to store fundraising group data in the database. In preferred embodiments, once a fundraising group has been created, the fundraising group has a group profile page. It may be possible to send invitations to individuals asking the individuals to become fundraising team members for a fundraising group that has been created through a fundraising website. The invitation may be sent electronically from the fundraising website via email, a social networking site, etc. but in some exemplary embodiments the invitation is delivered from the individual that created the fundraising group. A fundraising group may have a social network site page from which invitations to become fundraising team members are sent. A fundraising group page may be utilized for the sharing of messages, posting of pictures, etc. In some exemplary embodiments, one page is utilized by multiple fundraising groups.

Once an individual receives an invitation to join a fundraising group or fundraising team, he or she may be able to become a fundraising team member by visiting the fundraising website. An individual may become a member of a certain fundraising group by accessing the fundraising group's profile page. Accessing a group's profile page may require selecting a link to the group's profile page or performing a search for the group within the fundraising website. In a preferred exemplary embodiment, an individual does not become a fundraising team member until he or she has registered through the fundraising website. In exemplary embodiments where an individual has become a fundraising team member by registering at the fundraising website, the website may allow for the team member to generate an avatar or upload a photo on their member profile page. A confirmation message may be displayed upon the individual becoming a fundraising team member.

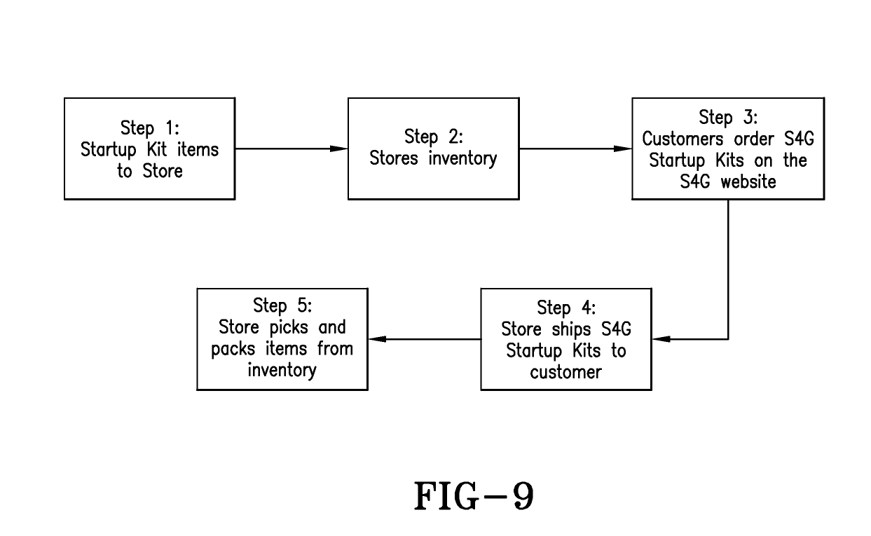

Once an individual has joined a fundraising team, he or she may be able to purchase a fundraising starter kit. FIG. 9 is a flowchart of fundraising kit fulfillment according to an example embodiment. In some exemplary embodiments, a fundraiser startup kit for a fundraising team member is purchased by someone other than the team member. In preferred examples, a fundraising startup kit comprises a device for measuring physical activity where the physical activity is the basis upon which the individual raises funds. In some exemplary embodiments, fundraising team members access the fundraising website to enter their physical activity. Entering physical activity may comprise receiving a request at a remote computer for the entry of physical activity data, sending the physical activity data from the remote computer to a server where the server then sends the physical activity data to a database.

In a preferred exemplary embodiment, an individual fundraising team member recruits sponsors where sponsors pledge donations based on the individual's performance of a physical activity. Pledges may be made by visiting the profile page of an individual fundraising team member and submitting a pledge. In some exemplary embodiments credit card information is entered such that a donation can be made upon the completion of the physical activity by the fundraising team member. An online payment service account may be utilized in some embodiments. When a fundraising website is utilized to make a pledge, sponsor information may be received at a server and stored in a database. The server may generate a confirmation message and send the confirmation message for display by a remote computer. The server may additionally receive confirmation that a sponsor accepts the terms and conditions of the fundraising website and send the confirmation to a database for storage. When a sponsor submits a pledge via the online payment service account, the online payment system may be utilized to collect donated funds. In some exemplary embodiments where a social networking site is used, an option on a web page may link potential sponsors to a member profile page. Additionally, a social networking site may be used to invite friends to become sponsors and/or fundraising team members.

Some exemplary embodiments comprise a team leader. The team leader may be the individual that created the fundraising group of fundraising team through the fundraising website. In exemplary embodiments comprising a team leader, the team leader may organize meetings, gatherings, etc. to motivate fundraising team members and/or to distribute information.

A preferred exemplary embodiment comprises a pledge period and a physical activity period. During the pledge period, fundraising team members solicit individuals for pledges. This is preferably done electronically but may be done through non-electronic means as well. Once the pledge period has expired, fundraising team members may begin performing a physical activity in order to raise as much money as possible based on the pledges they have received. In some exemplary embodiments, the pledge period continues into the physical activity period. Some fundraising team members may need to access the fundraising website to report their physical activity but in some exemplary embodiments, an electronic device such as a pedometer records the physical activity and causes physical activity data to be sent to a computer. In some exemplary embodiments, fundraising team members can purchase promotional items for an avatar that was created for their profile. The amount of promotional materials that can be purchased for the avatar may depend on the amount of physical activity the individual has expended during the physical activity period. Fundraising team members may receive motivational messages from the fundraising website throughout the fundraising process.

Sponsors may be able to monitor the physical activity of fundraising team members. Through this monitoring sponsors may be able to see the amount of physical activity that has been expended as well as how much of a donation they owe based on that activity. In a preferred exemplary embodiment, once the original donation amount pledged by a sponsor has been reached the sponsor receives an email asking him or her to consider increasing the pledge amount.

In an exemplary embodiment comprising a physical activity period, a fundraising website may track the physical activity of fundraising team members. The website may display the progress of individual fundraising team members as well as fundraising teams and fundraising groups. In a preferred exemplary embodiment, the fundraising website comprises a messaging system that permits fundraising team members to message each other, team leaders to message team members, sponsors to message fundraising team members, etc. A fundraising website may additionally comprise a retail page where products that support fundraising efforts may be purchased. A virtual store may also be available where fundraising team members can purchase accessories for avatars.

In a preferred exemplary embodiment, a physical activity period concludes upon the expiration of a certain number of days or on a certain date. Once the physical activity period has concluded, the team leader may receive payment via a check payable to the group for which funds were being raised (this is not necessarily the name of the fundraising group). Sponsors may receive email notifications letting them know the total of funds raised by an individual fundraising team member, a fundraising team, etc. In a preferred embodiment, a sponsor receives an email informing them of a donation they personally made to a fundraising effort based on the physical activity that has been expended and the sponsor's credit card is charged for that amount. Additionally, the sponsor may be given the option of donating a higher amount.

In an exemplary embodiment comprising a physical activity period, a server may monitor for the expiration of that period and generate an end of campaign message that is electronically sent to fundraising team members and sponsors. The message may thank and congratulate program participants and may also give ideas as to how participants may continue to incorporate physical activity in their lives. A server may determine how much money was made through the fundraising activity and cause a check to be printed for the respective organization. In some exemplary embodiments, a percent of fundraising proceeds may be deducted for maintenance costs, program fees, etc.

The exemplary embodiments herein disclosed are not intended to be exhaustive or to unnecessarily limit the scope of the invention. The exemplary embodiments disclosed were chosen and described in order to explain the principles of the invention so that others skilled in the art may practice the invention. Having shown and described exemplary embodiments of the invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

1. A computerized method for fundraising comprising one or more computers executing the instructions:
(a) receiving and storing fundraising group registration data comprising a fundraising group identifier;
(b) automatically generating a fundraising group display page comprising:
(1) said fundraising group identifier; and
(2) an option to create a team associated with said fundraising group;
(c) in response to selections of said option to create a team, receiving a plurality of requests to create a team associated with said fundraising group identifier;
(d) receiving for each of said plurality of requests:
(1) a team identifier for said team to be associated with said fundraising group identifier; and
(2) a team member identifier for each of a plurality of team members associated with said team identified by said team identifier; and
(e) receiving registration data from at least one member of each of said plurality of teams;
(f) comparing said registration data with said team identifiers and said team member identifiers to confirm each member is permitted to register with a team;
(g) arranging to distribute to each member a startup kit comprising a physical measurement device for measuring a physical activity to be performed by said team members;
(h) receiving from said physical measurement devices physical activity data for physical activity performed by said team members;
(i) receiving from sponsors pledges associated with said physical activity data for said team members;
(j) associating each of said pledges with a team member, a team identifier, or a fundraising group identifier;
(k) tracking fundraising totals according to at least one or more of:
(1) team member totals;
(2) each of said plurality of team totals; and
(3) said fundraising group total;
(l) in response to receiving a first request from a first user computer, generating a first display comprising a fundraising total for at least one of said team members, at least one of said teams, or said fundraising group; and
(m) in response to receiving a second request from a second computer user, generating a second display comprising:
(1) an identifier for one of said sponsors;
(2) at least one link to a past donation made by said sponsor; and
(3) at least one link to a recommended donation for said sponsor.

2. The computerized method of claim 1 wherein at least one of said team members is associated with a plurality of teams.

3. The computerized method of claim 1 wherein said physical activity is steps taken during a physical activity period.

4. The computerized method of claim 3 wherein said physical activity period is defined by a start date and an end date.

5. The computerized method of claim 1 further comprising receiving from at least one of said sponsors a request to generate a display comprising pledges from said sponsor to:
(a) said fundraising group;
(b) at least one of said plurality of teams; and
(c) at least one of said team members.

6. The computerized method of claim 1 further comprising receiving a request to generate a display comprising a team page identifying members of said team.

7. The computerized method of claim 1 wherein receiving registration data comprises receiving a request to purchase said startup kit for said physical activity to be performed by said team member.

8. A computerized system for fundraising comprising:
(a) one or more servers comprising programming instructions for:
(1) receiving and storing a fundraising group identifier for a fundraising group;
(2) automatically generating a fundraising group display page comprising:
(i) said fundraising group identifier; and
(ii) an option to create a team associated with said fundraising group;
(3) in response to selections of said option to create a team, receiving a plurality of requests to create a team associated with said fundraising group identifier;
(4) receiving for each of said plurality of requests:
(i) a team identifier for said team to be associated with said fundraising group identifier; and
(ii) a team member identifier for each of a plurality of team members associated with said team identified by said team identifier;
(5) receiving registration data from at least one member of each of said plurality of teams;
(6) comparing said registration data with said team identifiers and said team member identifiers to confirm each member is permitted to register with a team;
(7) arranging to distribute to each member a startup kit comprising a physical measurement device for measuring a physical activity to be performed by said team members;
(8) receiving from said physical measurement devices physical activity data for physical activity performed by said team members;
(9) receiving from sponsors pledges associated with said physical activity data for said team members; and
(10) associating each of said pledges with a team member, a team identifier, or a fundraising group entity; and
(b) a database for storing said physical activity data for physical activity performed by said team members;
(c) a first user computer for receiving a first display comprising a fundraising total for at least one of said team members, at least one of said teams, or said fundraising group entity; and
(d) a second user computer for receiving a second display comprising:
(1) an identifier for one of said sponsors;
(2) at least one link to a past donation made by said sponsor; and
(3) at least one link to a recommended donation for said sponsor.

9. The computerized system of claim 8 wherein at least one of said team members is associated with a plurality of teams.

10. The computerized system of claim 8 wherein said physical activity is steps taken during a physical activity period.

11. The computerized system of claim 10 wherein said physical activity period is defined by a start date and an end date.

12. The computerized system of claim 8 further wherein at least one of said servers further comprises programming instructions to respond to a request from a sponsor to generate a display comprising pledges from said sponsor to:
(a) said fundraising group entity;
(b) at least one of said plurality of teams; and
(c) at least one of said team members.

13. The computerized system of claim 8 wherein at least one of said servers further comprises programming instructions to respond to a request to generate a display comprising a team page identifying members of said team.

14. The computerized system of claim 8 wherein at least one of said servers further comprises programming instructions to respond to a request to purchase said startup kit for said physical activity to be performed by said team member.

15. A computerized method for fundraising comprising one or more computers executing the instructions:
(a) receiving and storing fundraising group registration data comprising a fundraising a group identifier for a fundraising group;
(b) automatically generating a fundraising group display page comprising:
(1) said fundraising group identifier; and
(2) an option to create a team associated with said fundraising group;
(c) in response to selections of said option to create a team, receiving a plurality of requests to create a team associated with said fundraising group identifier;
(d) receiving for each of said plurality of requests:
(1) a team identifier for said team to be associated with said fundraising group identifier; and
(2) a team member identifier for each of a plurality of team members associated with said team identified by said team identifier; and
(e) in response to receiving registration data from at least one member of each of said plurality of teams:
(1) confirming said team member is permitted to register with a team by comparing member registration data with said team identifiers and said team member identifiers; and
(2) arranging to distribute to said team member a startup kit comprising a physical measurement device for measuring a physical activity to be performed by said team member;
(f) associating with each of said plurality of teams an entity for receiving funds pledged to said fundraising group;
(g) receiving from said physical measurement device physical activity data for physical activity performed by said team members;
(h) receiving from sponsors pledges associated with said physical activity data for said physical activity to be performed by said team members;
(i) tracking fundraising totals according to said pledges and said physical activity performed by said team members;
(j) in response to receiving a first request from a first user computer, generating a first display comprising a fundraising total for said entity for receiving funds pledged to said fundraising group; and
(k) in response to receiving a second request from a second computer user, generating a second display comprising:
(1) an identifier for one of said sponsors;
(2) at least one link to a past donation made by said sponsor; and
(3) at least one link to a recommended donation for said sponsor.

16. The computerized method of claim 15 wherein said entity associated with each of said plurality of teams is the same entity.

17. The computerized method of claim 15 wherein said entity associated with each of said plurality of teams is a different entity.

18. The computerized method of claim 15 wherein at least one of said team members is associated with a plurality of teams.

19. The computerized method of claim 15 wherein said physical activity is steps taken during a physical activity period.

20. The computerized method of claim 15 wherein said physical activity period is defined by a start date and an end date.
